(19) United States
(12) Patent Application Publication
(10) Pub. No.: US 2011/0015998 A1
(43) Pub. Date: Jan. 20, 2011

(54) Use of vehicle data to interact with Internet online presence and status

(76) Inventor: Robert A. Hirschfeld, Austin, TX (US)

Correspondence Address: Robert A. Hirschfeld, 4900 Timberline Dr, Austin, TX, 78746, US

(21) Appl. No.: 12/836,578

(22) Filed: Jul. 15, 2010

Related U.S. Application Data
(60) Provisional application No. 61/270,882, filed on Jul. 15, 2009.

(51) Int. Cl. G06F 7/00; G08G 1/00; G06Q 30/00; G06F 15/16

(52) U.S. Cl. 705/14.49; 701/33; 701/29; 709/203

(57) ABSTRACT

This invention uses information obtained from a vehicle's on-board diagnostic (OBD) system to interact with networked systems via a smart phone to track online presence and status. The purpose of the invention is to automate status updates to networked services. These updates allow external services or individuals to remotely monitor a driver's status. Based on driver status, services including telephone and text messaging may change how they interact with the driver or the driver's device.

### CROSS-REFERENCE TO RELATED APPLICATIONS

This application claims the benefit of U.S. Provisional Applications Ser. No. 61/270,882, filed on Jul. 15, 2009 which is herein incorporated by reference in its entirety for all intents and purposes.

This application references components of U.S. application Ser. No. 12/624,409, filed on Nov. 24, 2009, U.S. application Ser. No. 12/614,401, filed on Nov. 7, 2009, U.S. application Ser. No. 12/836,576, filed on Jul. 14, 2010.

### BACKGROUND OF THE INVENTION

1. Field of the Invention

The present invention relates in general to use data from a vehicle on-board diagnostic information with external presence monitoring services and social networking applications.

2. Description of the Related Art

Vehicle On-Board Diagnostics (OBD) interfaces are standardized by statute on all modern vehicles. These interfaces conforms to both physical and protocol specifications. The communication protocols used by OBD include serial (e.g.: RS-232) and controller area network (CAN). There are at least 5 different standards based protocol specifications in use for current OBD systems including SAE J1850 PWM/VPW, ISO 9141-2, ISO 14230 KWP2000, and ISO 15765 CAN. Starting in 2008, all US vehicles must use ISO 15765 CAN based communication protocols for the OBD interface. Various standards are known for OBD, such as OBD-1, OBD 1.5, and OBD-II which include various standard interfaces, signal protocols, data communications, etc. The present disclosure contemplates future OBD configurations and implementations.

Smart phones or personal communication devices (PCD) have been widely available from companies such as Research In Motion (RIM). Recent introduction of the iPhone® by Apple Inc. and Android by Google phones have accelerated market penetration of these devices. Smart phones provide a broad range of capabilities, such as large readable displays, the ability to add new applications to the phone, network connectivity via cellular and/or WiFi, and global positioning system (GPS) location determination.

OBD display devices from companies including Autotap, ScanGauge allow drivers to display diagnostic data using a dedicated device and display. These after-market products allow drivers to monitor car diagnostics including fuel economy.

Integrated vehicle diagnostic displays are included in some automobile dashboards or displays to show current and average fuel economy.

Presence monitoring services (e.g.: Instant Messenger or Skype) and social networking applications (e.g.: Facebook or Twitter) are Internet based applications that allow users to expose aspects of their behavior to other users. For example, Skype users are able to indicate if they are available or busy. Twitter users are able to post short updates about their current activities and may attach their current location to the update information.

### BRIEF DESCRIPTION OF THE DRAWINGS

The benefits, features, and advantages of the present invention will become better understood with regard to the following description, and accompanying drawings where:

FIG. 1 is a block diagram of an integrated driving application that uses OBD data to update online status.

FIG. 2 is a block diagram of an integrated driving application that uses OBD data and remote status tracking to determine when to allow or block external communications with the driver.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The invention involves using on-board diagnostic data from a vehicle to provide automatic updates for online status and presence. This integration provides value by improving the accuracy and breadth of the data. More accurate the data increases the value of the network to the user and enables new applications. It is anticipated that this integration will create new business opportunities based on improved data accuracy and availability.

The implementation of this invention involves sending information based on the vehicle's OBD data. This data includes, but is not limited to, the vehicle's fuel efficiency, speed, emissions status, or maintenance status. It may also be based on a historical analysis of the OBD data. The data for this analysis can be traced on the car systems or on an external networked system. Once this data is available, it can be used to update the driver's online status or presence.

For example, a user's Skype™ status may be automatically changed from “available” to “away” when the driver is known to be driving in their car. It is anticipated that applications will add new presence status to better describe driving status. For example, a user's Skype™ status may be changed form “away” to “driving” when the user is driving the their car. If they are later stuck in traffic, their presence indicator could be updated to be “available, in traffic.”

Another example, a user's Twitter™ feed could up updated automatically to reflect their driving behavior. For example, when they reach work, their feed could be automatically updated to reflect that they are at work, their fuel efficiency, or how long it took for them to commute. Status information is not limited to vanity updates. If the driver is going to be late for an appointment, the system can automatically notify the people they are meeting.

A contemplated commercial application for this invention is to notify drivers when their vehicle is in need of routine maintenance and direct advertising to them as needed. For example, after 3000 miles a driver could be automatically directed to a garage, such as Jiffy Lube™, that has no wait for service.

It is contemplated that this invention could be accomplished with a networked embedded system that has no user interface intermediate user interface. In this model, the data would go directly from the OBD interface to the remote applications.

To further enhance driver safety, vehicles may be configured to require that the driver's PCD be connected to the vehicle OBD system before the vehicle can be started. This would ensure that vehicle status data can be used by the invention.

It is recognized that the nature of online presence will change over time. This invention is forward looking and anticipates that future presence systems may follow a different interaction model.

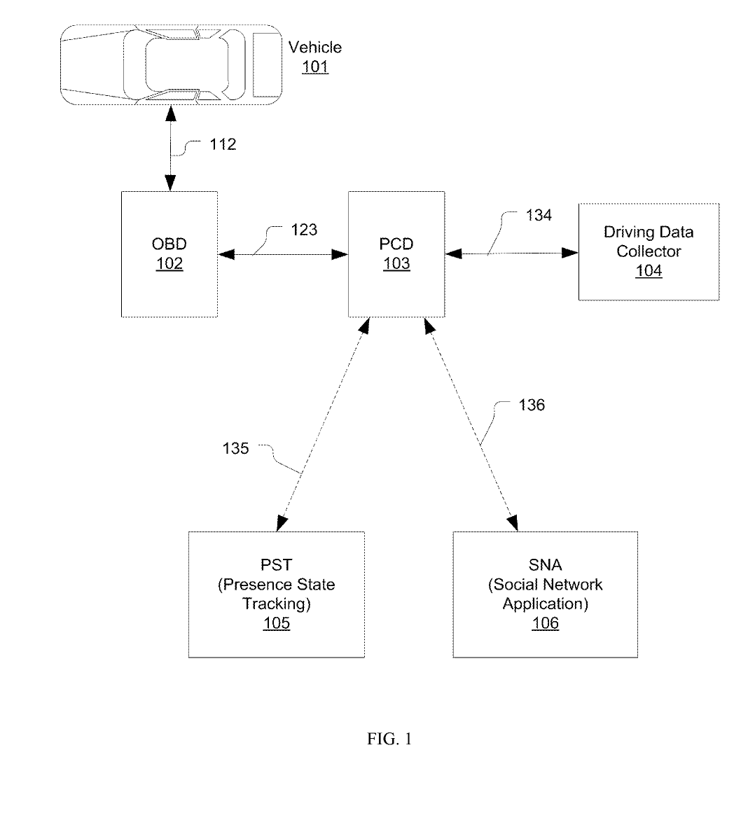

FIG. 1 is a block diagram of a data collection system for vehicle 101 drivers that relies on information from the vehicle 101 on-board diagnostic OBD 102 system collected by the driver's personal communication device (PCD) 103 such as a smart phone or other device. OBD 102 data is combined with sensor data from the PCD 103 and buffered by a driving data collector 104 application. This application uses the PCD 103 network connections 135 and 136 to provide status information to presence state tracking 105 or social network 106 applications. Link 135 and 136 are bidirectional and allow the driver to receive information about other drivers status or location as appropriate.

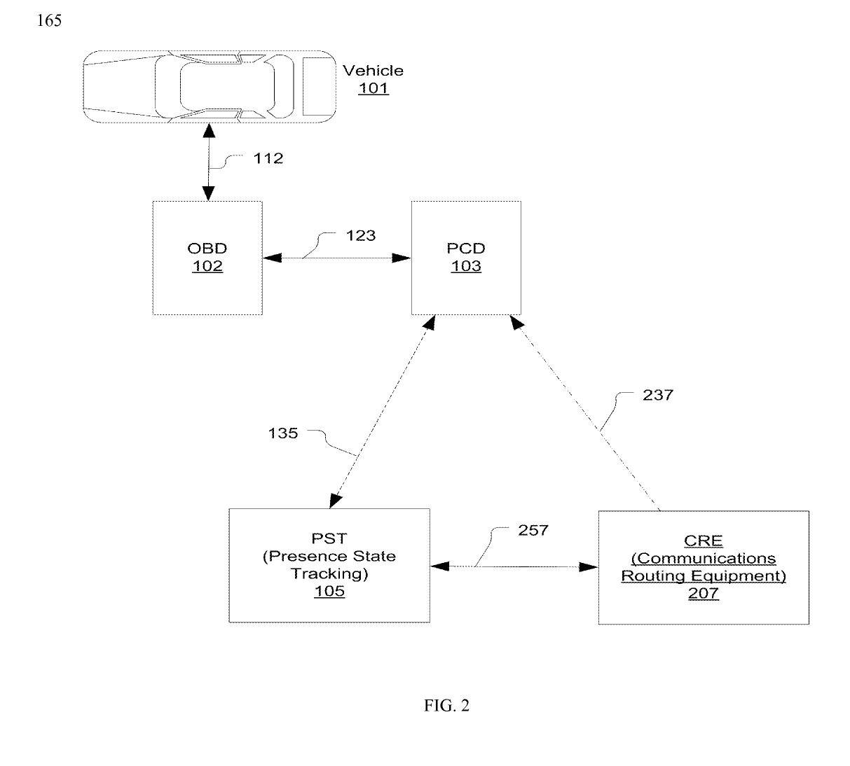

FIG. 2 is a block diagram of a data collection system for vehicle 101 drivers that relies on information from the vehicle 101 on-board diagnostic OBD 102 system collected by the driver's personal communication device (PCD) 103 such as a smart phone or other device. Status updates provided by the PCD 103 using it's network connection 135 are tracked by the presence state tracking PST 105 application. The PST 105 communicates 257 with communication routing equipment 207 to limit calls, text messages, or other communications 237 depending on the driver's status. This allows distracting communications to be blocked until the driver's status indicates that she is ready for communications.

1. A process in which vehicle on-board diagnostic (OBD) data is used to update online presence or status; personal communication device (PCD) in communication with a vehicle OBD interface; and a remote service that provides presence or status information to other applications based on information collected by the PCD

2. The process of claim 1 where information provided is the presence for an instant messenger (IM) client, chat utility, telephone client, online avatar or other virtual persona

3. The process of claim 1 where the status update is used to provide information for a social networking site

4. The process of claim 3 where the status update is a statement about vehicle performance

5. The process of claim 3 where the status update is a request for assistance based on vehicle diagnostics

6. The process of claim 1 where the state of the driver reflects their current driving activities, such as driving, parked, stuck in traffic, speeding, in accident, broken, etc.

7. The process of claim 1 in driver status is used to make decisions about diverting or blocking communication with the PCD

8. The process of claim 7 in which phone calls, text messages, or other communications are allowed or rejected based on the status

9. A process in which vehicle on-board diagnostic (OBD) data is used to provide general information for other drivers or interested parties

10. The process of claim 9 in which the information is the driver's current speed or location

11. The process of claim 9 in which the information is the driver's rank compared to other drivers

12. The process of claim 11 in which driver information is posted to relevant social networking applications such as Facebook or Twitter

13. The process of claim 11 in which drivers control the visibility of their updates

14. The process of claim 9 in which the information is the traffic conditions

15. A process in which vehicle on-board diagnostic (OBD) data is used to support commercial activities such as advertisements are provided based on car maintenance, traffic conditions, or driver behavior patterns such as speeding

16. The process of claim 1 in which drivers are aware of each other

17. The process of claim 1 in which data from the users calendar is used to determine their driving objective

18. The process of claim 17 in which the calendar information is used to inform other meeting participants if the driver is going to be late.
